(19) United States
(12) Patent Application Publication
(10) Pub. No.: US 2025/0362407 A1
(43) Pub. Date: Nov. 27, 2025

(54) INFORMATION PROCESSING DEVICE AND INFORMATION PROCESSING METHOD

(71) Applicant: Hitachi Astemo, Ltd., Hitachinaka-shi, Ibaraki (JP)

(72) Inventors: Shunsuke MATSUO, Hitachinaka-shi, Ibaraki (JP); Shigenori HAYASE, Hitachinaka-shi, Ibaraki (JP); Yuichi KOMORIYA, Hitachinaka-shi, Ibaraki (JP)

(73) Assignee: Hitachi Astemo, Ltd., Hitachinaka-shi, Ibaraki (JP)

(21) Appl. No.: 19/108,367

(22) PCT Filed: Oct. 21, 2022
(86) PCT No.: PCT/JP2022/039320

§ 371 Date: Mar. 3, 2025

(51) Int. Cl. G01S 13/931

(52) U.S. Cl. CPC G01S 13/931

(57) ABSTRACT

An information processing device that generates integration information by performing integration processing of object information acquired by a plurality of sensors that detect an object for each cycle includes a weight setting unit that sets a weight to the object information, and an integration processing unit that generates integration information by performing integration processing of the object information in a processing order determined by at least the weight, and ends the integration processing of the current cycle in accordance with a lapse of time or the number of objects related to the object information used for the integration processing of the current cycle. The weight setting unit sets the weight of the object information based on an integration history indicating whether or not the object information has been used for the integration processing for each cycle.

### TECHNICAL FIELD

The present invention relates to an information processing device and an information processing method that perform integrated processing on a target obtained by a sensor.

### BACKGROUND ART

Driving assistance systems and automatic driving systems have been developed to achieve various purposes such as reduction of traffic accidents, reduction of burden of drivers, improvement of fuel efficiency for reducing global environmental burden, and provision of transportation means to vulnerable road users for realizing a sustainable society. In the driving assistance system and the automatic driving system, a plurality of sensors are provided in a vehicle in order to monitor the periphery of the vehicle instead of a driver. In addition, a system that performs automatic braking on a specific target such as a pedestrian or a vehicle by using recognition results of a plurality of sensors mounted on a vehicle has been developed.

Background art of the present technical field includes the following prior art. PTL 1 discloses an electronic control device including a priority giving unit that gives priority to data sensed in accordance with an external environment situation and an own vehicle situation, a priority determination unit that dynamically changes and determines the priority given to the data, a data management unit that stores data to which the priority is given, an application execution unit, and a data selection unit that selects data to be transferred from the data management unit to the application execution unit in accordance with the priority (see Abstract).

### CITATION LIST

### Patent Literature

PTL 1: WO 2020/066305 A

### SUMMARY OF INVENTION

### Technical Problem

However, PTL 1 discloses that the priority is determined for each target and processing is performed on a target having high priority, but a processing end condition of the function is not clear. For example, in a case where there are many targets (for example, a pedestrian, an oncoming vehicle, or the like) important for control determination in a driving control device in a scene in which the number of detected targets increases, such as a right/left turning scene at an intersection, the number of targets as a target of integration processing increases and the processing load increases, and the processing is not completed within a given execution cycle. At this time, when the writing of a result to a database, which is performed as post-processing after the integration processing, is abnormally ended, or the previous value remains at time of writing and the control determination is performed with the previous value, the driving control device may make an erroneous control determination, which may cause an erroneous operation of an automatic brake.

In addition, PTL 1 discloses that only count-up is performed in a cycle in which no processing is performed for a target having low priority. However, in a case where no processing is performed for estimation of the position of a target or the like, the reliability remains low when the priority becomes high. Therefore, there is a concern that the association and the position estimation of the target are erroneously performed when the integration processing is performed thereafter.

In view of the above circumstances, there has been a demand for a method of completing integration processing within a processing cycle even though a large amount of target information is input.

### Solution to Problem

To solve the above problem, an information processing device according to an aspect of the present invention generates integration information by performing integration processing of object information acquired by a plurality of sensors that detect an object for each cycle. The information processing device includes a weight setting unit that sets a weight to the object information, and an integration processing unit that generates integration information by performing integration processing of the object information in a processing order determined by at least the weight, and ends the integration processing of the current cycle in accordance with a lapse of time or the number of objects related to the object information used for the integration processing of the current cycle. Then, the weight setting unit sets the weight of the object information based on an integration history indicating whether or not the object information has been used for the integration processing for each cycle.

### Advantageous Effects of Invention

According to at least an aspect of the present invention, even though a large amount of target information is input, it is possible to complete the integration processing within a processing cycle based on a prescribed processing condition.

Problems, configurations, and effects other than those described above will be clarified by the following description of embodiments.

### BRIEF DESCRIPTION OF DRAWINGS

FIG. 1 is a functional block diagram of an information processing device having a function of performing integration processing in order of weights based on an integration history, according to a first embodiment of the present invention.

FIG. 2 is a block diagram illustrating an example of a hardware configuration of the information processing device according to the first embodiment of the present invention.

FIG. 3 is a flowchart illustrating an example of a procedure of weight setting processing by the information processing device according to the first embodiment of the present invention.

FIG. 4 is a flowchart illustrating an example of a procedure of integration processing by an integration processing unit of the information processing device according to the first embodiment of the present invention.

FIG. 5 is a diagram illustrating an example of a case where determination is made by the number of pieces as a method of determining an integration processing (main processing) target according to the first embodiment of the present invention.

FIG. 6 is a diagram illustrating an example of a case where determination is made by a threshold value as the method of determining the integration processing (main processing) target according to the first embodiment of the present invention.

FIG. 7 is a diagram illustrating an outline of tracker management (update) in the information processing device according to the first embodiment of the present invention.

FIG. 8 is a diagram illustrating an outline of the tracker management (new registration) in the information processing device according to the first embodiment of the present invention.

FIG. 9 is a conceptual diagram illustrating an information processing method of performing only count-up for a target having low priority in the prior art.

FIG. 10 is a conceptual diagram (1) illustrating method of performing count-up and time synchronization for a target having low priority in the information processing device according to the first embodiment of the present invention.

FIG. 11 is a diagram (1) illustrating an example of the integration processing at a certain integration performing time in the information processing device according to the first embodiment of the present invention.

FIG. 12 is a conceptual diagram (2) illustrating the method of performing the count-up and the time synchronization for the target having low priority in the information processing device according to the first embodiment of the present invention.

FIG. 13 is a diagram (2) illustrating an example of the integration processing at a certain integration performing time in the information processing device according to the first embodiment of the present invention.

FIG. 14 is a flowchart illustrating an example of a procedure of integration processing including simple integration by an information processing device according to a second embodiment of the present invention.

FIG. 15 is a conceptual diagram illustrating a method of performing simple integration in addition to count-up and time synchronization for a target having low priority in the information processing device according to the second embodiment of the present invention.

### DESCRIPTION OF EMBODIMENTS

Hereinafter, examples of modes for carrying out the present invention (referred to as “embodiments” below) will be described with reference to the accompanying drawings. In the present specification and the accompanying drawings, the same components or components having substantially the same function are denoted by the same reference signs, and redundant description will be omitted. In addition, in a case where there are a plurality of components having the same or similar functions, description may be made by adding different subscripts to the same reference signs. In addition, in a case where it is not necessary to distinguish the plurality of components, the description may be made by omitting the subscripts.

### First Embodiment

### Configuration of Information Processing Device

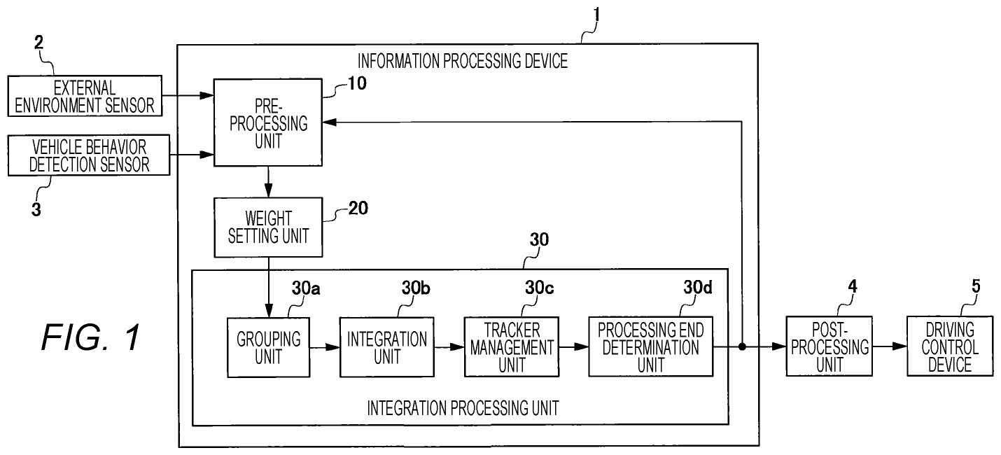

First, a configuration of an information processing device according to a first embodiment of the present invention will be described with reference to FIG. 1. FIG. 1 is a functional block diagram of the information processing device having a function of performing integration processing in order of weights based on an integration history, according to the first embodiment of the present invention.

As illustrated in FIG. 1, an information processing device 1 includes a pre-processing unit 10, a weight setting unit 20, and an integration processing unit 30. Output signals of an external environment sensor 2 and a vehicle behavior detection sensor 3 are input to the information processing device 1. Furthermore, the information processing device 1 is connected to a driving control device 5 via the post-processing unit 4.

The external environment sensor 2 is one or more sensors that detect a target around the own vehicle. Examples of the external environment sensor 2 include a camera (visible light, near-infrared, mid-infrared, or far-infrared camera), a millimeter-wave radar, a light detection and ranging (LiDAR), a sonar, a time of flight (TOF) sensor, a sensor obtained by combining the above sensors, or the like. Detection information of the external environment sensor 2 includes at least an ID, a position, a speed, and an object type of target. The target is a point of interest obtained from information detected by the external environment sensor 2. The target is not limited to a human, a moving object such as a vehicle, or a structure and may include a traveling line, a hole, light, reflected light, or the like. Note that the external environment sensor 2 may be simply referred to as a “sensor”.

The vehicle behavior detection sensor 3 is a sensor group that detects a speed, a yaw rate, and a steering angle of the own vehicle. As an example, the vehicle behavior detection sensor 3 includes a wheel speed sensor, an acceleration sensor, a yaw rate sensor, a steering angle sensor, and the like.

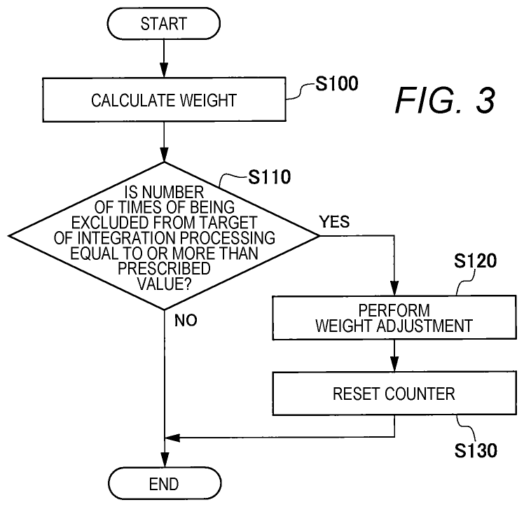

Details of the pre-processing unit 10, the weight setting unit 20, and the integration processing unit 30 will be described later with reference to FIGS. 3 to 15.

### Hardware Configuration of Information Processing Device

The information processing device 1 (electronic control device) and the external environment sensor 2 include a computer (microcontroller) including an arithmetic device, a memory, and an input/output device.

The arithmetic device includes a processor and executes a program stored in the memory. A part of processing performed by the arithmetic device executing the program may be performed by another arithmetic device such as a micro-processing unit (MPU). In addition, hardware such as a field programmable gate array (FPGA) or an application specific integrated circuit (ASIC) may be used as another arithmetic device.

The memory includes a RAM and a ROM that is a non-volatile storage element. The ROM stores an invariable program (for example, basic input/output system (BIOS)) and the like. The RAM is a high-speed and volatile storage element such as a dynamic random access memory (DRAM) or a non-volatile storage element such as a static random access memory (SRAM), and stores a program executed by the arithmetic device and data used when the program is executed.

The input/output device is an interface that externally transmits processing contents by the electronic control device or the sensor and receives data from the outside, in accordance with a predetermined protocol.

The program executed by the arithmetic device is stored in a non-volatile memory which is a non-transitory storage medium of the electronic control device or the sensor.

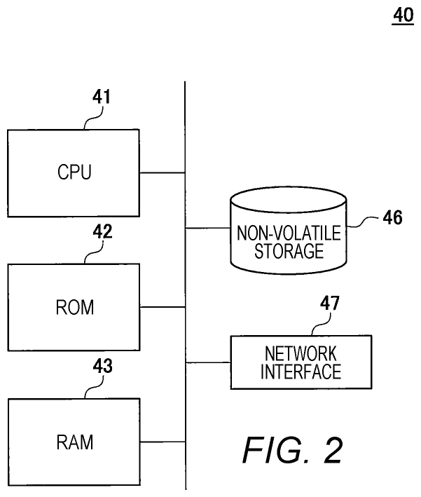

FIG. 2 is a block diagram illustrating an example of a hardware configuration of the information processing device 1. A computer 40 illustrated in FIG. 2 is hardware used as a so-called computer.

The computer 40 includes a central processing unit (CPU) 41, a read only memory (ROM) 42, a random access memory (RAM) 43, a non-volatile storage 46, and a network interface 47 each connected to a bus.

The CPU 41 is an example of a processor as the arithmetic device. The ROM 42 and the RAM 43 are examples of memories. The non-volatile storage 46 is a non-volatile storage element having a larger capacity than the memory. A program for realizing each function of the embodiment of the present invention is stored in the non-volatile storage 46. The non-volatile storage 46 is an example of a non-transitory computer-readable recording medium. The program may be stored in the ROM 42.

The network interface 47 includes a communication device or the like that controls communication with another device. The network interface 47 is an example of the input/output device. The function of each block of the information processing device 1 (FIG. 1) will be described in detail.

### Pre-Processing Unit

The pre-processing unit 10 uses, as inputs, target information of a target detected by the external environment sensor 2, own vehicle behavior information detected by the vehicle behavior detection sensor 3, and target information of a fusion target (also referred to as a “tracker”) which is a result obtained by performing integration processing of target information of a plurality of targets in a previous cycle, and converts the target information of the target and the own vehicle behavior information into a prescribed unified format. Examples of the conversion processing into the predetermined unified format include data conversion (for example, unit conversion and coordinate conversion), additional information calculation (for example, calculation of reliability of target), and time synchronization.

Target information of a target detected by the external environment sensor 2 includes at least a position, a speed, a target ID, and an object type. Note that the target ID is assigned in a cycle in which the target is detected for the first time, and thereafter, the same sign is assigned when the same target as that in the previous cycle is tracked. Further, the above format includes at least “time” and “position (coordinates)”.

“Time” refers to estimation of target information of the target at an integration performing time by using a time difference in consideration of the time difference between the time detected by the external environment sensor 2 and the integration performing time. For example, in the case of the “position”, the calculation is performed as “position of target at sensor integration performing time=position at sensor detection time+(time difference×speed at sensor detection time)”.

In addition, for the fusion target, since “time difference=integration performing cycle” is obtained, for example, “position of target at sensor integration performing time=position at previous performing time+(integration performing cycle×speed of target at previous performing)” is calculated.

In addition, the position and speed may be estimated in consideration of the turning behavior of the own vehicle by using the speed and the steering angle or the yaw rate of the own vehicle. For the coordinates, for example, target information of the target in which a sensor installation position is set as the origin, the forward direction (front-rear direction) of the sensor is set as an x-axis, and the leftward direction (right-left direction) of the sensor is set as a y-axis is converted into target information based on a coordinate system in which the center of the own vehicle is set as the origin, the forward direction (front-rear direction) of the own vehicle is set as the x-axis, and the leftward direction (right-left direction) of the own vehicle is set as the y-axis. The pre-processing unit 10 outputs information of the target converted into the format to the weight setting unit 20.

### Weight Setting Unit

The weight setting unit 20 uses, as an input, the target information of the target output from the pre-processing unit 10, and sets a weight by using the target information of the target based on the flowchart illustrated in FIG. 3.

FIG. 3 is a flowchart illustrating an example of a procedure of weight setting processing by the information processing device 1. First, the weight setting unit 20 calculates a weight for target information based on the pre-processed information (target information, own vehicle behavior information) output from the pre-processing unit 10 (S100). In this weight calculation, a weight is calculated for target information required by an application using an output result of the information processing device 1. When this application is an autonomous emergency brake (AEB), for example, an index such as a small distance from the own vehicle or time to collision (TTC) is calculated by using the target information of the detected target, thereby setting the weight of the target information. This weight may be set not only for a single index but also for a plurality of indexes such as the small distance from the own vehicle and whether or not the target type is a vehicle. At this time, a weighting factor is applied in accordance with the importance levels of the plurality of indexes to obtain a sum. Note that the target to which the weight is set is the target (sensor target) and the fusion target obtained by the individual sensors.

Then, after the weights are set for all targets, for the fusion target (tracker), with reference to the value of a counter indicating the number of times (the number of cycles) of the fusion target being excluded from the target of the integration processing, it is determined whether or not the number of times of the fusion target being excluded from the target of the integration processing is equal to or more than a prescribed value (S110). If the number of times of the fusion target being excluded from the target of the integration processing is equal to or more than the prescribed value (YES in S110), weight adjustment: is performed such that the tracker is included in the target of the integration processing in the current cycle (S120). In the weight adjustment, the higher the weight, the higher the priority of the integration processing. Thus, processing of adding the numerical value of “weight due to non-integration processing during a period equal to or longer than a threshold value” to the weight of the target that satisfies the condition is performed.

Next, a zero value is set by resetting the counter related to the tracker whose weight has been adjusted (S130).

In a case where the number of times of being excluded from the target of the integration processing in Step S110 is less than the prescribed value (NO in S110), or after the process of Step S130, this processing is ended.

### Integration Processing Unit

The integration processing unit 30 uses, as an input, target information of a target for which pre-processing has been performed by the pre-processing unit 10 and whose weight has been set by the weight setting unit 20, and performs integration processing by using target information of targets detected by a plurality of sensors.

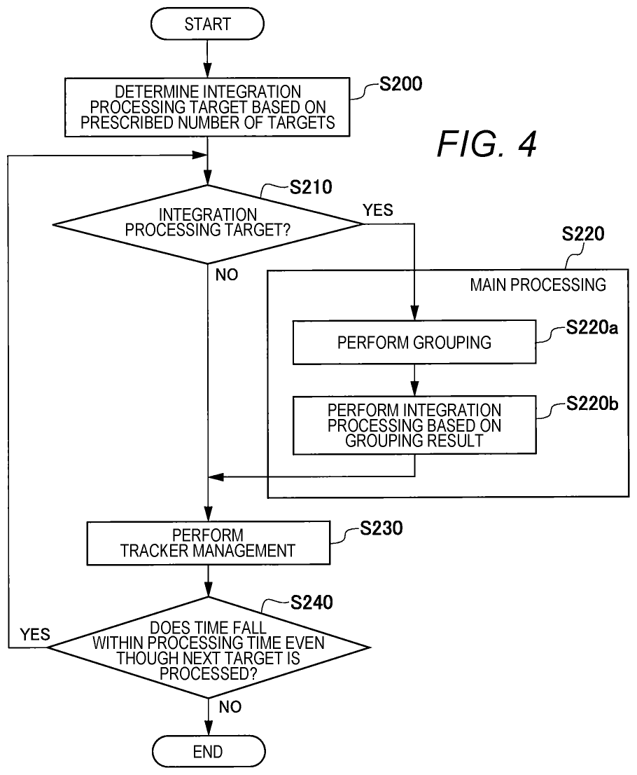

FIG. 4 is a flowchart illustrating an example of a procedure of the integration processing by the integration processing unit 30 of the information processing device 1. As illustrated in FIG. 1, the integration processing unit 30 includes at least three processing blocks. That is, the integration processing unit 30 includes a grouping unit 30a that groups a plurality of pieces of target information between targets detected by the tracker or the sensor, an integration unit 30b that generates (integrates) the grouped target information of the targets, and a tracker management unit 30c that newly registers, updates, or deletes a fusion target.

Before performing processing by these processing blocks, the integration processing unit 30 determines a target as an integration processing target based on the prescribed number of targets (S200), and repeats the similar processing in order of priority. Here, processing for a certain target will be described. This priority is the same concept as the priority disclosed in PTL 1, and the priority of the integration processing increases as the set weight increases.

After the process of Step S200, the integration processing unit 30 determines whether or not the target is an integration processing target (S210). In a case where the target is not the integration processing target (NO in S210), the process proceeds to tracker management in Step S230. On the other hand, in a case where the target is the integration processing target (YES in S210), the process proceeds to main processing (grouping and integration processing) in Step S220.

### Method of Determining Integration Processing (Main Processing) Target

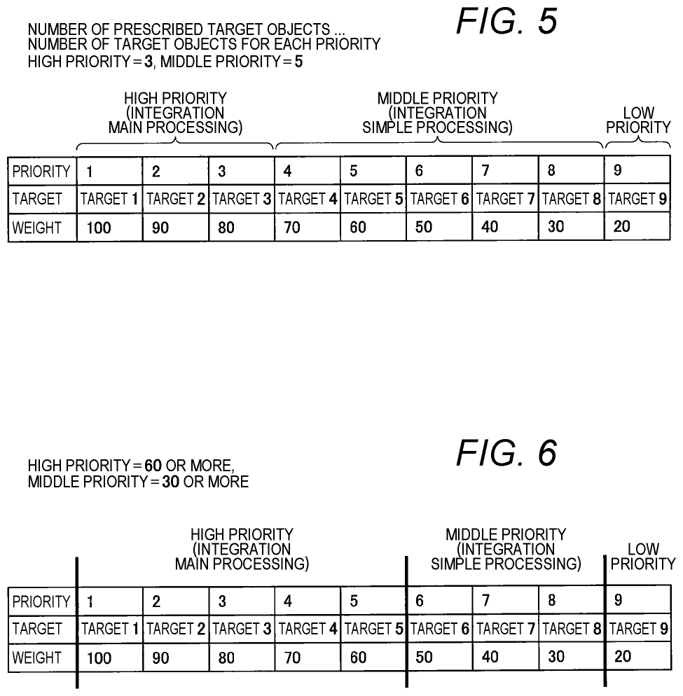

Here, a method of determining the target of the integration processing (main processing in Step S220) according to the present embodiment will be described with reference to FIGS. 5 and 6.

FIG. 5 is a diagram illustrating an example of a case where determination is made by the number of pieces as the method of determining an integration processing (main processing) target. A premise is a method in which the prescribed condition of the integration processing target is the prescribed number of targets, and the integration processing (main processing) target is determined based on the prescribed number of targets. The prescribed number of targets is the number of targets prescribed for each priority. In this example, the high priority is set to 3, and the middle priority is set to 5. FIG. 5 illustrates an example in which weights 100 to 20 and priorities 1 to 9 are assigned to the respective targets 1 to 9. Since the integration main processing is performed on three targets in descending order of priority, the targets 1 to 3 corresponding to the priorities 1 to 3 are the targets of the integrated main processing. Note that the five targets 4 to 8 having middle priority are targets of integration simple processing which will be described in a second embodiment. The target 9 having low priority is excluded from the target of both the main processing and simple processing.

As described above, k targets may be classified as targets having high priority, j targets may be classified as targets having middle priority, and the remaining targets may be classified as targets having low priority. Note that, in FIGS. 4 and 5, the prescribed number of targets (number) is illustrated as an example of the prescribed condition, but the prescribed condition is not limited to this example, and may be a threshold value. An example of determining an integration processing (main processing) target by using a threshold value as the prescribed condition will be described below with reference to FIG. 6.

FIG. 6 is a diagram illustrating an example of a case where determination is made by the threshold value as the method of determining an integration processing (main processing) target. A premise is a method in which the prescribed condition of the integration processing target is the threshold value, and the integration processing (main processing) target is determined based on the threshold value. In this example, for example, in a case where the threshold value is expressed by 0 to 100, the threshold value of the high priority is set to equal to or more than 60, and the threshold value of the middle priority is set to equal to or more than 30. Similarly to FIG. 5, FIG. 6 illustrates an example in which weights 100 to 20 and priorities 1 to 9 are assigned to the respective targets 1 to 9. In order to perform the integration main processing on the target whose weight corresponding to the high priority is equal to or more than the threshold value “60”, the targets 1 to 5 corresponding to the weights 100 to 60 (priorities 1 to 5) are the target of the integrated main processing. Note that the three targets 6 to 8 having a weight of less than “60” and a weight “30” or more corresponding to the middle of the priority are targets of the integration simple processing which will be described in the second embodiment. The target 9 having low priority is excluded from the target of both the main processing and simple processing.

The description returns to the flowchart of FIG. 4. In the main processing in Step S220, the grouping unit 30a determines whether or not a plurality of pieces of detection information among a plurality of pieces of detection information is the detection information of the same target by using at least position information among the plurality of pieces of detection information regarding the target for the integration processing. Then, in a case where it is determined that the plurality of pieces of detection information are the detection information of the same target, the grouping unit 30a determines a combination of a plurality of pieces of target information regarding the target in order to generate a fusion target (S220a).

When the combination is determined, in a case where processing is performed on the target information based on the fusion target of the previous cycle, identity determination is performed on the target information of the fusion target. Here, the identity determination with respect to estimation information of the fusion target is performed by using at least the position of the target information of the fusion target and the positions of a plurality of pieces of target information regarding the target. For example, an error covariance matrix is obtained from the installation position and specification information of the sensor, a Mahalanobis distance that is a probabilistic distance is calculated from the error covariance matrix, and the Mahalanobis distance is compared with a threshold value to determine the identity. In other words, in the integration processing (main processing), grouping is performed by threshold determination using a reliable distance (Mahalanobis distance) obtained from the error covariance matrix. In a case where it is determined that pieces of the target information of the fusion target are identical, the ID of the integration processing result of a plurality of pieces of corresponding target information is the ID of the fusion target determined to be identical. The grouping unit 30a outputs the plurality of pieces of target information of the target grouped for each fusion target ID to the integration unit 30b.

The integration unit 30b uses, as an input, a plurality of pieces of detection information regarding the target, which are grouped by the grouping unit 30a, and performs processing (integration processing) of estimating plausible target information based on the plurality of grouped pieces of detection information regarding the target (S220b).

In an example of the integration method, for example, an error characteristic may be given as a parameter in advance for each external environment sensor 2, and the position and speed of the sensor target having the smallest error characteristic among the grouped target information may be adopted as the position and speed of the fusion target. Alternatively, in another example of the integration method, the covariance matrix may be calculated from the target information of the target based on the error characteristic, and the position and speed calculated by the probability average may be adopted. In addition to giving the error characteristic of the sensor in advance, the error characteristic may be estimated during the integration, or the error characteristic included in the target information of the external environment sensor 2 may be used. In addition, even though there is one detection result of the sensor included in the fusion target, the integration unit 30b outputs the detection result as the fusion target.

In the following description, even in a case where one detection result of the sensor is grouped, an expression of “integration” is used as the fusion target. In this case, the position and the speed are equal to the detection result of the sensor, or the position and the speed of the target at the integration performing time estimated by the pre-processing unit 10 are used. The integration unit 30b outputs the integration result to the tracker management unit 30c. In addition, the integration unit 30b counts up the number of times that the integration processing has not been performed on the tracker on which the integration processing has not been performed, after performing the integration processing on all the integration processing targets. The integration unit 30b outputs the target information of the fusion target subjected to the integration processing to the tracker management unit 30c.

Then, in the case of NO determination in Step S210 or after the process of Step S220b, the tracker management unit 30c manages the target. For example, the tracker management unit 30c uses, as an input, the fusion target subjected to the integration processing output from the integration unit 30b, and overwrites (updates) or newly registers the target information of the tracker in accordance with the content of the integration processing (S230).

### Update of Target Information of Tracker

For example, in the integration processing, in a case where the target information detected in the current cycle is integrated in association with the tracker existing in the previous cycle, the tracker management unit 30c updates the target information of the fusion target having the same ID as the tracker.

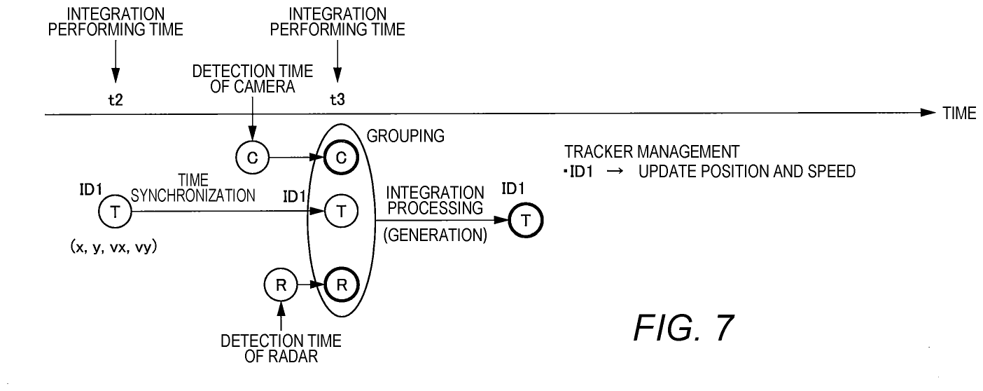

FIG. 7 is a diagram illustrating an outline of tracker management (update) in the information processing device 1. In FIG. 7, the horizontal axis represents time, and an example in which a fusion target T having a target ID “ID1” exists at an integration performing time t2 is illustrated. The position of the fusion target T of “ID1” is (x, y), and the speeds in an x-direction and a y-direction are (vx, vy). Before the next integration performing time t3, the detection time of the camera and the detection time of the radar arrive, and a target C detected by the camera and a target R detected by the radar are obtained. At the integration performing time t3, the grouping unit 30a groups the target C and the target R into the fusion target T of “ID1” existing at the previous integration performing time t2, and the integration unit 30b performs integration processing (generates new target information) on the fusion target T, the target C, and the target R which have been grouped and have “ID1”. Then, the tracker management unit 30c updates the target information (position, speed) of the fusion target T of “ID1”.

### New Registration of Tracker

In addition, in the integration processing, in a case where targets detected by the sensor are not associated with the tracker existing in the previous cycle but are subjected to the integration processing in association with each other, the tracker management unit 30c adds the fusion target as a newly generated tracker.

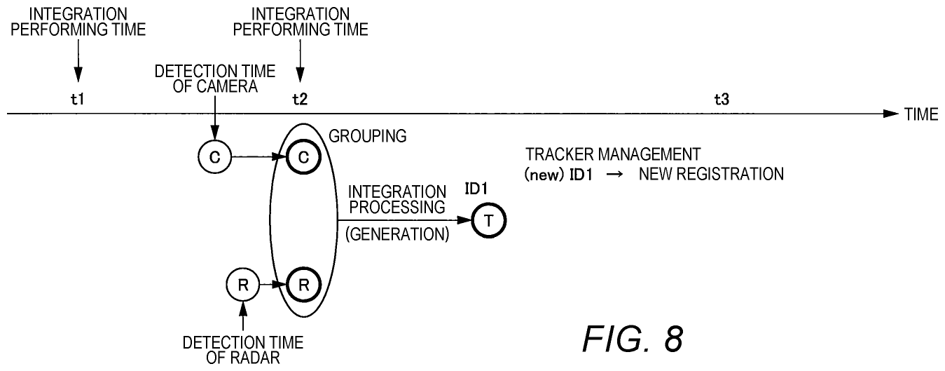

FIG. 8 is a diagram illustrating an outline of tracker management (new registration) in the information processing device 1. In FIG. 8, the horizontal axis represents time, and an example in which a fusion target T does not exist at an integration performing time t1 is illustrated. Before the next integration performing time t2, the detection time of the camera and the detection time of the radar arrive, and a target C detected by the camera and a target R detected by the radar are obtained. At the integration performing time t2, the grouping unit 30a groups the target C and the target R, and the integration unit 30b performs integration processing on the grouped target C and target R to generate the fusion target T and give a target ID (for example, “ID1”) to the fusion target T. Then, the tracker management unit 30c newly registers the fusion target T of “ID1” generated by the integration processing. Note that the target such as the sensor target and the fusion target and the target information are stored in the RAM 43 or the non-volatile storage 46.

Furthermore, in a case where no target detected by the sensor is associated with the tracker in the integration processing and the target is not associated with the tracker in the previous integration processing, and in a case where the number of times of being not associated with the tracker satisfies the prescribed value (corresponding to NO determination in Step S110), the tracker management unit 30c deletes the tracker.

After completing the tracker management in Step S230 for the target, the processing end determination unit 30d determines whether or not the time falls within the processing time even though the next target is processed (S240). In a case where it is determined that the time falls within the processing time (YES in S240), the integration processing unit 30 determines whether or not the next target is the integration processing target (S210). On the other hand, in a case where it is determined that the time does not fall within the processing time (NO in S240), the integration processing unit 30 ends the integration processing. The integration processing unit 30 outputs the target information of the fusion target processed by the tracker management unit 30c to the post-processing unit 4. The integration processing unit 30 generates integrated information (fusion target) by performing integration processing of the object information (sensor target, fusion target) in the processing order determined by at least the weight, and ends the integration processing of the current cycle in accordance with the lapse of time or the number of objects related to the object information used in the integration processing of the current cycle.

### Post-Processing Unit

The description returns to the configuration of the information processing device 1 illustrated in FIG. 1. The post-processing unit 4 uses, as an input, the target information of the fusion target output from the tracker management unit 30c, and writes the target information of the fusion target in a database (not illustrated) of the system. The database of the system may be configured by using the non-volatile storage 46 of the information processing device 1 or another memory. Note that the post-processing unit 4 may be included in the information processing device 1 (for example, a post-process of the integration processing unit 30).

The driving control device 5 controls driving of the vehicle (own vehicle) on which the information processing device 1 is mounted, based on the target information of the target written in the database by the information processing device 1. The driving control device 5 can be configured by using an ECU.

### Processing End Condition

Next, the processing end condition of the integration processing determined by the processing end determination unit 30d (FIG. 1) of the integration processing unit 30 will be described.

In the integration processing unit 30, the processing end determination unit 30d determines whether or not the next target can be processed each time the processing of the target is ended. With this determination, in a case where it is determined that the processing can be performed, the determined processing is performed on the next target, and in a case where it is determined that the processing cannot be performed, the processing of the integration processing unit 30 is ended up to the previous target, and the processing of the post-processing unit 4 is started.

Here, in Step S210 described above, the integration processing unit 30 determines whether or not the next target is a target to be subjected to the integration processing based on threshold determination based on a predetermined number of targets or the weight. In a case where the next target is a target to be subjected to the integration processing, the processing end determination unit 30d estimates a processing time required for the integration processing. For example, in consideration of an error in the processing time estimated in advance in consideration of an increase in load due to heat of the ECU and the like in addition to the processing time obtained in advance by calculation from the hardware specification of the ECU and the matrix calculation performed in the integration processing, the sum of the maximum value of the error and the processing time obtained in advance is set as the processing time required for the next integration processing.

Furthermore, the processing end determination unit 30d refers to a timer (not illustrated) of the system, and determines whether or not a series of processing (pre-processing, integration processing, and post-processing) performed by the information processing device 1 in the remaining time within the processing cycle can be completed based on the time elapsed from the start of the processing (specifically, the first pre-processing in the current cycle) by the information processing device 1 in the current cycle and the previously obtained processing time required for the next integration processing.

In a case where the processing end determination unit 30d determines that the series of processing can be completed within the processing cycle, the information processing device 1 performs processing (pre-processing, integration processing, and post-processing) related to the next integration processing. In the present embodiment, the processing end determination unit 30d determines whether or not the series of processing can be completed by the processing end determination based on the prescribed number of targets (number of pieces) or the processing end determination based on the remaining time in the processing cycle. Therefore, it is desirable that the prescribed target number is set with a margin (predetermined margin) so that a series of processing is completed within the processing cycle. In a case where it is determined that the series of processing cannot be completed within the processing cycle, the information processing device 1 ends the processing. In addition, in a case where the next target is not the target to be subjected to the integration processing, the integration processing is ended at that time.

According to the above process end determination, even though the number of targets detected by the sensor increases, the processing can be completed within the processing time given to the fusion function.

Note that, in a second embodiment which will be described later, in a case where there is a simple integration target, the processing end determination unit 30d determines whether a series of processing can be completed by both the processing end determination based on the prescribed number of targets (number of pieces) and the processing end determination based on the remaining time within the processing cycle.

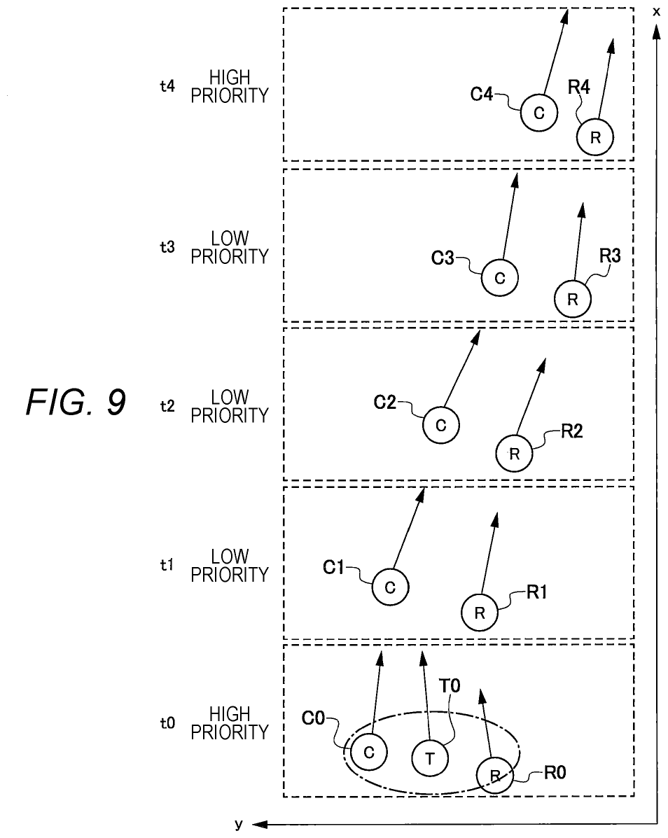

Next, with reference to FIGS. 9 and 10 to 13, a difference between a conventional technique in which only count-up of a cycle (number of times) in which the integration processing is not performed is performed for a target having low priority and the present invention in which time synchronization is performed in addition to the count-up will be described.

### Conventional Method of Performing Only Count-Up

FIG. 9 is a conceptual diagram illustrating an information processing method of performing only count-up for a target having low priority in the prior art. The x-axis represents a coordinate in the forward direction of the own vehicle, and the y-axis represents a coordinate in the leftward direction of the own vehicle.

In the prior art, as illustrated in FIG. 9, a scene is considered in which a target (“camera target” below) C0 detected by a camera and a target (“radar target” below) R0 detected by a radar exist at time t0, and a fusion target T0 generated by grouping the camera target C0 and the radar target R0 exists. That is, the priority of each target at the time t0 is high.

At time t1, the fusion target T0 at the time t0 is determined to be a target having low priority by the weight setting unit 20 and the integration processing unit 30, and is a target to which the integration processing with the camera target C1 and the radar target R1 at the time t1 are not subjected. Therefore, target information of the fusion target at the time t1 is the same target information as the fusion target T0 at the time t0.

Thereafter, in a case where it is determined that the fusion target is a target having low priority also at time t2 and time t3, similarly, the fusion target T0 at the time to is not subjected to the integration processing with a camera target C2 (C3) and a radar target R2 (R3) at the time t2 (time t3). Therefore, target information of the fusion target at the time t2 and the time t3 is the same as the target information of the fusion target T0 at the time t0.

At time t4, in a case where the priority of the fusion target T0 becomes high and the fusion target T0 becomes a target of the integration processing, grouping is performed for the fusion target T0. However, since the fusion target T0 has not been processed from the time t0, the fusion target T0 has the same position and speed as those at the time t0, even at the time t4. Therefore, it is determined that the target information of the fusion target T0 is not identical to the camera target C4 and the radar target R4 at the time t4, and the fusion target T0, the camera target C4, and the radar target R4 are not grouped.

### Method of Performing Count-Up and Time Synchronization

Next, a difference from the embodiment of the present invention in which time synchronization is performed in addition to the count-up of the cycle (number of times) in which the integration processing is not performed will be described.

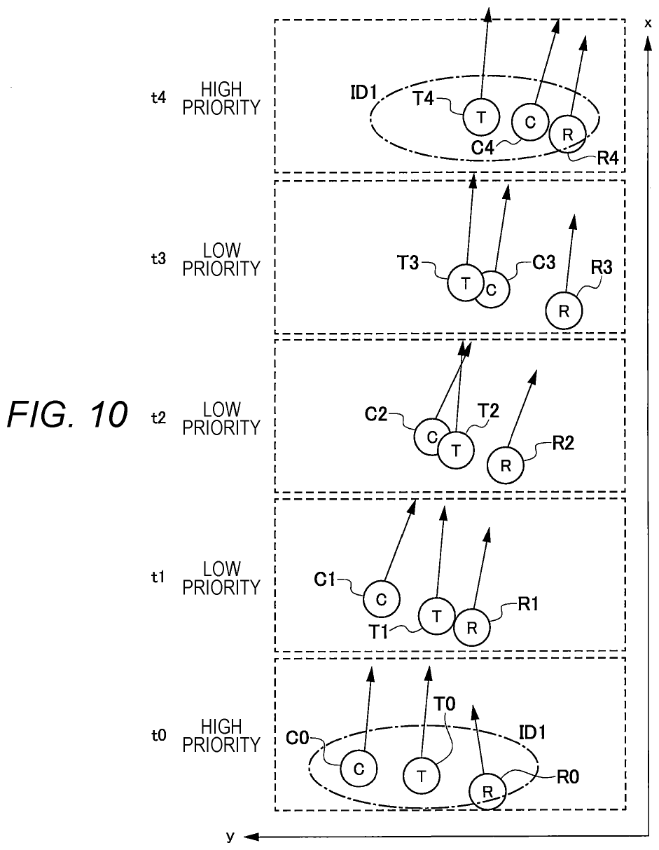

FIG. 10 is a conceptual diagram (1) illustrating a method of performing count-up and time synchronization for a target having low priority in the information processing device 1. The x-axis represents a coordinate in the forward direction of the own vehicle, and the y-axis represents a coordinate in the leftward direction of the own vehicle.

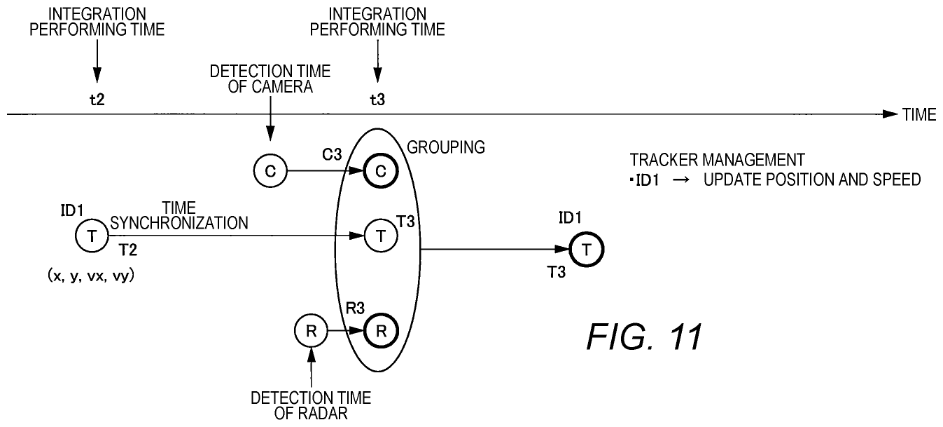

FIG. 11 is a diagram (1) illustrating an example of integration processing at a certain integration performing time in the information processing device 1.

In FIG. 10, a scene is considered in which a camera target C0 detected by the camera at time t0 and a radar target R0 detected by the radar exist, and a fusion target T0 generated by grouping the camera target C0 and the radar target R0 exists. That is, the priority of each target at the time t0 is high. It is assumed that the target ID of the fusion target T0 is “ID1”.

At time t1, the fusion target T0 of “ID1” at the time to is determined to be a target having low priority by the weight setting unit 20 and the integration processing unit 30, and is a target to which the integration processing with the camera target C1 and the radar target R1 at the time t1 are not subjected. However, in the present embodiment, the grouping unit 30a and the integration unit 30b of the integration processing unit 30 perform time synchronization (update) on the fusion target T0 at the time t0 and the camera target C1 and the radar target R1 at the time t1. In the time synchronization, the integration unit 30b estimates (updates) the position of a fusion target T1 of “ID1” at least at the time t1 based on at least the position and the speed of the fusion target T0 of “ID1” generated at the time to. Similarly, at time t2, the position of a fusion target T2 of “ID1” at least at the time t2 is estimated (updated) based on the target information of the fusion target T1 of “ID1” at the previous time.

FIG. 11 illustrates an example of time synchronization at time t3. Also at the time t3, time synchronization (update) is performed on the fusion target T2 which has been time-synchronized at the time t2, and a camera target C3 and a radar target R3 at time t3. That is, the integration unit 30b estimates (updates) the position of a fusion target T3 of “ID1” at least at the time t3 based on at least the position and the speed of the fusion target T2 of “ID1” generated at the time t2.

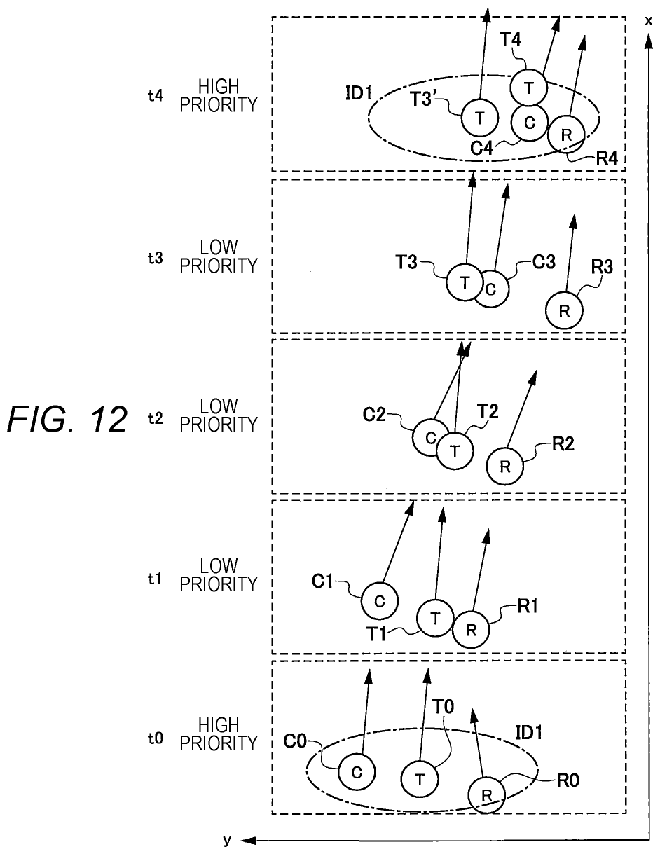

FIG. 12 is a conceptual diagram (2) illustrating the method of performing the count-up and the time synchronization for the target having low priority in the information processing device 1. The x-axis represents a coordinate in the forward direction of the own vehicle, and the y-axis represents a coordinate in the leftward direction of the own vehicle.

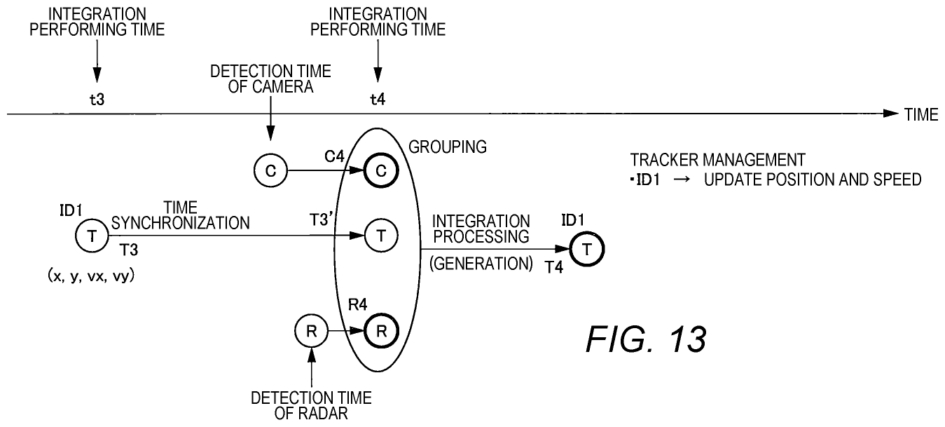

FIG. 13 is a diagram (2) illustrating an example of integration processing at a certain integration performing time in the information processing device 1.

FIGS. 12 and 13 illustrate the state of each target from time t3 to time t4. Also at the time t4, the position of a fusion target T3′ of “ID1” at the time t4 is estimated (updated) based on the target information of the fusion target T3 of “ID1” at the previous time t3. As described with reference to FIGS. 10 and 11, it is possible to roughly reduce the error between the sensor target and the registered fusion target from the time t1 to the time t3 when the priority of the target is low. Therefore, in a case where the priority of the target is high again at the time t4 and the integration processing is performed, the grouping and the integration processing with the camera target C4 and the radar target R4 detected at the time t4 can be performed based on the target information of the fusion target T3′ estimated by the time synchronization until before the time t4 (here, time t3). With such integration processing, the position of the fusion target T4 after the integration processing at least at the time t4 can be estimated (updated) from the target information of the fusion target T3′, and the camera target C4 and the radar target R4.

As described above, the information processing device (information processing device 1) according to the present embodiment generates integration information by performing integrated processing of object information (sensor target) acquired by a plurality of sensors that detect an object for each cycle. The information processing device includes: a weight setting unit (weight setting unit 20) that sets a weight to object information (sensor target, fusion target); and an integration processing unit (integration processing unit 30) that generates integration information (fusion target) by performing integration processing of the object information (sensor target, fusion target) at least in a processing order determined by the weight, and ends the integration processing of the current cycle in accordance with a lapse of time or the number of objects related to the object information used for the integration processing of the current cycle. Then, the weight setting unit is configured to set the weight of the object information based on an integration history (the number of times of being excluded from the target of the integration processing) indicating whether or not the object information is used for the integration processing for each cycle.

With the information processing device having such a configuration according to the present embodiment, even though a large amount of object information is input, the integration processing can be completed within the processing cycle by ending the integration processing of the current cycle in accordance with the lapse of time or the number of objects related to the object information used for the integration processing of the current cycle.

### Second Embodiment

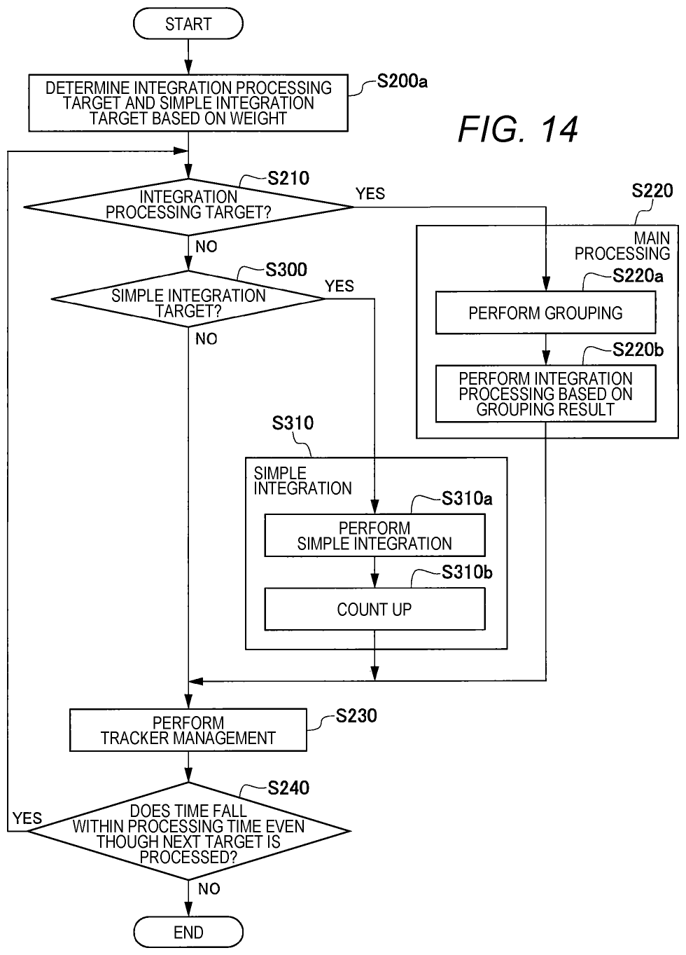

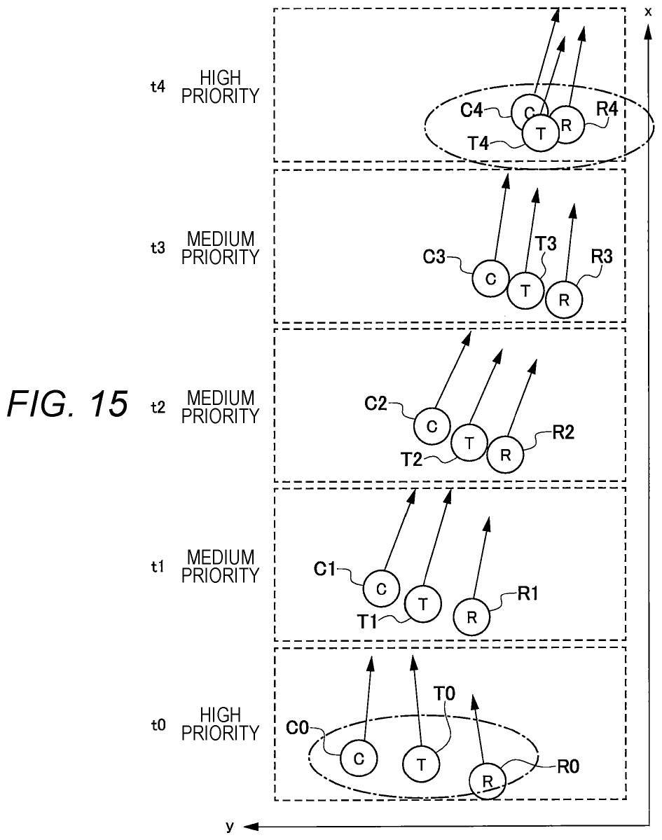

The second embodiment is an example in which the information processing device 1 according to the first embodiment has a simple integration function based on weight setting. An information processing device according to the second embodiment will be described below with reference to FIGS. 14 and 15. In the second embodiment, differences from the first embodiment will be mainly described, and the same components are denoted by the same reference signs, and the description thereof will be omitted.

FIG. 14 is a flowchart illustrating an example of a procedure of integration processing including simple integration by an information processing device 1 according to the second embodiment.

FIG. 15 is a conceptual diagram illustrating a method of performing simple integration in addition to count-up and time synchronization for a target having low priority in the information processing device 1 according to the second embodiment. The x-axis represents a coordinate in the forward direction of the own vehicle, and the y-axis represents a coordinate in the leftward direction of the own vehicle.

In the information processing device 1 according to the present embodiment, in the processing of the integration processing unit 30 illustrated in FIG. 14, not only the integration processing for a target having high priority (main processing in Step S220) but also the simple integration for the target having middle priority (simple integration target) (Step S310) is performed.

First, before performing the processing by each processing block, the integration processing unit 30 (FIG. 1) determines the target of the integration processing (main processing) and the target of the simple integration based on the weight of the target (S200a), and repeats the similar processing in order of priority.

Then, the integration processing unit 30 determines whether or not the target is an integration processing (main processing) target (S210). In a case where the target is the integration processing (main processing) target (YES in S210), the process proceeds to main processing (grouping and integration processing) in Step S220. On the other hand, in a case where the target is not the integration processing (main processing) target (NO in S210), the integration processing unit 30 determines whether or not the target is the simple integration target (S300). Here, in a case where the target is not the simple integration target (NO in S300), the process proceeds to tracker management in Step S230. On the other hand, in a case where the target is the simple integration target (YES in S300), the process proceeds to the main process (simple integration, count up) in Step S310.

For example, as illustrated in FIG. 6, two different priority (weight) threshold values are set, and whether the target is the integration processing target (YES in S210) or the simple integration target (YES in S300) is determined by comparing the threshold values with the priority of the target. In addition, as illustrated in FIG. 5, it may be determined whether the target is the integration processing target or the simple integration target based on the number of targets (prescribed number of targets) set in advance for each priority.

In the simple integration in Step S310, the integration processing unit 30 performs simple integration processing having a smaller calculation load and poor estimation accuracy than the integration processing (Step S310a). In the simple integration in Step S310a, the grouping unit 30a does not perform the error covariance matrix calculation as simple grouping, but determines that, for example, a target within a certain distance from the position of the fusion target is the same as the fusion target. In addition, as simple position estimation, for example, the integration unit 30b sets the average value of the target information of the camera target or the radar target determined to be the same by the simple grouping as the position of the fusion target after the simple processing. Alternatively, as another example of the simple position estimation, the integration unit 30b may adopt, for example, target information of a radar target as the x coordinate and target information of a camera target as the y coordinate in accordance with a combination of sensor targets simply grouped in consideration of sensor characteristics.

After the process of Step S310a, the integration unit 30b counts up the number of times that the integration processing has not been performed on the tracker for which the integration processing has not been performed (Step S310b).

Then, in the case of NO determination in Step S300, after the process of Step S220b or after the process of Step S310b, the tracker management unit 30c manages the target. For example, the tracker management unit 30c uses, as an input, the fusion target which has been subjected to the integration processing (main processing) or the simple integration and output from the integration unit 30b, and overwrites (updates) or newly registers the target information of the tracker in accordance with the content of the processing (S230).

Then, after ending the tracker management in Step S230, the processing end determination unit 30d determines whether or not the time falls within the processing time even though the next target is processed (S240), and proceeds to Step S210 or ends the integration processing in accordance with the determination result.

With such integration processing (main processing, including simple integration), not only the count-up but also the time synchronization is performed for the fusion target in which the priority is not high (for example, middle priority) at time t1 to time t3 in FIG. 15, and at the same time, compensation is performed for position estimation by simple integration (S310a). As a result, in a case where the priority becomes high in the subsequent processing cycle and a target that is a target of the integration processing appears, it is possible to correctly perform the integration processing by using the fusion target that is subjected to the simple integration. In the example illustrated in FIG. 15, it can be confirmed that the contents (position and moving direction) of each sensor target and each piece of target information of each of fusion targets T1 to T3 at the time t1 to the time t3 are aligned as compared with the example of the sensor target and the fusion target illustrated in FIGS. 10 and 12.

In the description of the above-described embodiment, the in-vehicle electronic control unit (ECU) calculates (that is, performs integration processing) the correction value of the sensor coordinate transformation. However, a computer communicably connected to the vehicle may calculate the correction value of the sensor coordinate transformation.

As described above, in the information processing device (information processing device 1) according to the present embodiment, the integration processing unit (integration processing unit 30) is configured to perform time synchronization and simple integration that is simple integration processing on object information (sensor target, fusion target) that is not subjected to integration processing (S310).

As described above, in the present embodiment, the object information including the position at each time can be estimated by a method different from the integration processing by performing the time synchronization and the simple integration processing on the target having low priority determined by the weight. Therefore, even in a case where the priority of the object information is increased from the low priority, the integration processing can be performed with high accuracy.

Further, in the present embodiment, the integration processing unit (the integration processing unit 30) is configured to perform simple integration on object information (sensor target, fusion target) that has not been subjected to the integration processing after the integration processing is ended. As a result, by performing the simple integration after the end of the integration processing based on the priority determined by the weight, the integration processing having a high processing priority can be reliably completed within the processing cycle as compared with the simple integration.

Further, in the present embodiment, the integration processing unit (the integration processing unit 30) may be configured to end the integration processing of the current cycle in accordance with the lapse of time, the number of objects related to the object information used for the integration processing of the current cycle, and the number of objects related to the object information used for the simple integration of the current cycle. As a result, it is possible to end the integration processing of the current cycle even in the middle of the simple integration.

Note that the present invention is not limited to the above-described embodiments, and it is obvious that various other application examples and modifications can be taken without departing from the gist of the present invention described in the claims. For example, the above-described embodiments have been specifically described in detail in order to describe the present invention in an easy-to-understanding manner, and are not necessarily limited to those having all the described configurations. In addition, some of the components of one embodiment can be replaced with a component of another embodiment. In addition, components of other embodiments can be added to the configuration of one embodiment. In addition, other components can be added, replaced, and deleted for a part of the configuration of each embodiment.

In addition, some or all of the above-described configurations, functions, processing units, and the like may be realized by hardware, for example, by designing with an integrated circuit. A processor in a broad sense such as a field programmable gate array (FPGA) or an application specific integrated circuit (ASIC) may be used as hardware. In addition, information such as programs, tables, and files for realizing the functions of the embodiments can be stored in a recording device such as a memory, a hard disk, or a solid state drive (SSD), or a recording medium such as an IC card, an SD card, an optical disk, or a magneto-optical disk.

In addition, in the above-described embodiments, control lines information lines considered to be necessary for description are illustrated, and not all control lines and information lines are necessarily illustrated in terms of products. In practice, it may be considered that almost all the components are connected to each other.

### REFERENCE SIGNS LIST

1 information processing device
2 external environment sensor
3 vehicle behavior detection sensor
4 post-processing unit
5 driving control device
10 pre-processing unit
20 weight setting unit
30 integration processing unit
30a grouping unit
30b integration unit
30c tracker management unit
30d processing end determination unit

1. An information processing device that generates integration information by performing integration processing of object information acquired by a plurality of sensors that detect an object for each cycle, the information processing device comprising:
a weight setting unit that sets a weight to the object information; and
an integration processing unit that generates integration information by performing integration processing of the object information in a processing order determined by at least the weight, and ends the integration processing of the current cycle in accordance with a lapse of time or the number of objects related to the object information used for the integration processing of the current cycle,
wherein the weight setting unit sets the weight of the object information based on an integration history indicating whether or not the object information has been used for the integration processing for each cycle.

2. The information processing device according to claim 1,
wherein the integration processing unit performs time synchronization and simple integration that is simple integration processing, on the object information that is not subjected to the integration processing.

3. The information processing device according to claim 2,
wherein the integration processing unit performs the simple integration on the object information that has not been subjected to the integration processing, after the integration processing is ended.

4. The information processing device according to claim 2,
wherein the integration processing unit ends the integration processing of the current cycle in accordance with the lapse of time, the number of objects related to the object information used for the integration processing of the current cycle, and the number of objects related to the object information used for the simple integration of the current cycle.

5. An information processing method by an information processing device that generates integration information by performing integration processing of object information acquired by a plurality of sensors that detect an object for each cycle, the information processing method comprising:
a process of setting a weight to the object information; and
a process of generating integration information by performing integration processing of the object information in a processing order determined by at least the weight, and ending the integration processing of the current cycle in accordance with a lapse of time or the number of objects related to the object information used for the integration processing of the current cycle,
wherein, in the process of setting the weight, the weight of the object information is set based on an integration history indicating whether or not the object information has been used for the integration processing for each cycle.
